(19) United States
(12) Patent Application Publication
(10) Pub. No.: US 2008/0235167 A1
(43) Pub. Date: Sep. 25, 2008

(54) METHODS AND SYSTEMS FOR SELECTING MOLECULAR STRUCTURES

(76) Inventors: David N. Beratan, (US); Weitao Yang, (US)

Correspondence Address: LIPTON, WEINBERGER & HUSICK, P.O. Box 203, Exton, PA, 19341, US

(21) Appl. No.: 12/032,414

(22) Filed: Feb. 15, 2008

Related U.S. Application Data
(60) Provisional application No. 60/890,389, filed on Feb. 16, 2007.

(51) Int. Cl. G06F 15/18

(52) U.S. Cl. 706/14

(57) ABSTRACT

A method and system for the design of molecules having specific desired properties by continuously optimizing electron-nuclear attraction potentials within a space. Using a linear combination of atomic potentials, optimal and near-optimal structures may be designed without enumerating and separately evaluating each of the combinatorial number of possible structures, thus achieving improved design throughput.

The present application claims the benefit under all applicable U.S. statutes, including 35 U.S.C. §119(e), to U.S. Provisional Application No. 60/890,389 filed Feb. 16, 2007, titled Methods and Systems For Selecting Molecular Structures, in the names of David N. Beratan and Weitao Yang.

This invention was made with government support under grants from DARPA and from the NIH. The US Government has certain rights to this invention.

### FIELD OF INVENTION

The present invention concerns methods and systems for selecting or screening for a molecular structure having a physical property of interest.

### BACKGROUND OF THE INVENTION

The astronomical number of accessible discrete chemical structures makes rational molecular design extremely challenging (Lipinski, C., Hopkins, Nature 432, 855-861 (2004)). For example, the number of medium sized organic molecules considered to be possible drug candidates exceeds Avogadro's number (P. Ertl, J. Chem. Inf. Comput. Sci. 43, 374-380 (2003)). At present, there does not appear to be a viable experimental or theoretical scheme to search this rich structural space in a systematic and purposeful manner. The tremendous challenge of molecular optimization in such a vast space arises from the discrete nature of molecules. Each molecule is unique in structure and properties, and no set of continuous variables categorizes properties in the molecular space. We introduce an approach that “smoothes out” the chemical properties in the space of discrete target structures and thus makes efficient optimization possible. Smoothing of the property surfaces is shown schematically in FIG. 1.

Much molecular design currently relies on: (a) modifying known favorable motifs and exploring property changes, (b) developing structure-function relations and using rational design strategies (Marder, S. R. et al., Science 252, 103-106 (1991)), and (c) employing combinatorial methods (Terrett, N. K. Combinatorial Chemistry (Oxford University Press, New York, 1998); Franceschetti, A. & Zunger, A. Nature 402, 60-63 (1999); Kuhn, C. & Beratan, D. N. J. Phys. Chem. 100, 10595-(1996)). These approaches are limited either in their scope or in their efficiency. Efforts that aim to control quantum dynamical processes and to design optical waveguides (Rice, S. A. & Zhao, M. Optical Control of Molecular Dynamics (Wiley, New York, 2000); Brumer, P. & Shapiro, M. Principles of the quantum control of molecular processes (Wiley, New York, 2003); Warren, W. S. et al., Science 259, 1581-1589 (1993); Rabitz, H. & Zhu, W. S. Acc. Chem. Res. 33, 572-578 (2000); Pant, D. K. et al., App. Opt. 38, 3917-923 (1999)) confront similar design challenges to those of molecular design. However, dynamical control focuses on tuning field-matter interactions for specific molecules. For solids, average medium models, like the virtual crystal model (VCM) (Shim, K. & Rabitz, H., Phys. Rev. B 57, 12874-12881 (1998)), employ “counterfeit” or average atom descriptions to explore how properties vary with stoichiometry, but VCMs do not address molecule design issues. Accordingly there remains a need to to establish a flexible framework for the theoretical design of optimized molecules.

### SUMMARY OF THE INVENTION

In embodiments of this invention, we formulate the design of molecules with specific tailored properties as performing a continuous optimization in the space of electron-nuclear attraction potentials. The optimization is facilitated by using a linear combination of atomic potentials (LCAP), a general framework that creates a smooth property landscape from an otherwise unlinked set of discrete molecular-property values. A demonstration of this approach is given for the optimization of molecular electronic polarizability and hyperpolarizability (Marder, S. R. et al., Nature 388, 845-851 (1997)). We show that the optimal structures can be determined without enumerating and separately evaluating the characteristics of the combinatorial number of possible structures, a process that would be much slower. The LCAP approach may be used with quantum or classical Hamiltonians, suggesting possible applications to drug design and new materials discovery.

A first aspect of the present invention is, accordingly, a method of selecting a molecular structure having a physical property of interest, comprising:

(a) providing a set of chemical substituents including an information set for each of the substituents (e.g., said information set comprising chemical valency, bond lengths and bond angles)

(b) specifying said physical property of interest;

(c) optionally, specifying at least one chemical constraint of the molecular structure;

(d) generating at least one connectivity map for a family of molecular structures from said information set, said connectivity map comprising a plurality of substituent locations;

(e) generating a list of possible chemical substituents for each location on said at least one connectivity map;

(f) generating a set of weighting coefficients for each substituent at each location from said list of possible chemical substituents and said at least one connectivity map;

(g) generating by numerical optimization a subset of at least one optimum structure from said physical property of interest, said list of possible chemical substituents at each site, and said set of weighting coefficients.

A second aspect of the invention is a computer program product comprising a computer usable storage medium having computer-readable program code stored in the media, the computer readable program code configured to perform a method as described herein above and below.

A third aspect of the invention is a computer system configured to perform a method as described herein above and below.

The foregoing and other objects and aspects of the present invention are explained in greater detail in the drawings herein and the specification set forth below.

### BRIEF DESCRIPTION OF THE DRAWINGS

FIG. 1. A schematic representation is shown of properties values. Bar heights represent electronic polarizabilities for 21 specific candidate structures (chemical structure is noted) and the smooth surface on which the property optimization is performed. Establishing a well behaved property surface that interpolates among the realizable molecules is a key aspect of the approach described here.

FIG. 2. LCAP based on six different chemical substituents (—CH₃, —OH, —NH₂, —F, ‘3Cl, and —SH) at two sites.

FIG. 3. Polarizability contours. The contours (10⁻²⁵esu) are drawn as a function of the two —SH weighting coefficients. The lower left corner corresponds to CH₃CH₃, the upper right corresponds to H₂S₂ (fixed 90° torsion angle), and the two other corners correspond to CH₃SH.

FIG. 4. Polarizability and the maximum derivative |dα/dt_{A}^{R}|. Values are plotted versus the number of function evaluations beginning with uniform coefficients on all six functional groups (—CH₃, —OH, —NH₂, —F, —Cl, and —SH). The red, green, blue, cyan, magenta, and yellow bars in the insets indicate the relative weights, respectively. L and R labels refer to the left and right chemical groups, respectively.

FIG. 5. First electronic hyperpolarizability and the maximum derivative. |dβ_{μ}/dt_{A}^{R}|. Values are plotted versus the number of function evaluations beginning with uniform coefficients on all six functional groups (—CH₃, —OH, —NH₂, —F, —Cl, and —SH). The red, green, blue, cyan, magenta, and yellow bars indicate the relative weights of the six functional groups, respectively.

FIG. 6. Flow chart for an expanded LCAP-based optimization procedure that includes multiple fragment conformers and self-consistent geometry optimization.

FIG. 7. The polarizability and max |dα/dtᵢ| versus the number of α evaluations beginning with uniform coefficients and the two functional group —CH₃ and —SH on left (L) and right (R) sites.

FIG. 8. The coefficients of —CH₃ and —SH versus the number of cα evaluations beginning with uniform coefficients at the two designable sites.

FIG. 9. The coefficients versus the number of α evaluations beginning with uniform coefficients on six functional groups (—CH₃, —OH, —NH₂, —F, —Cl and —SH).

FIG. 10. The coefficients at each point versus the number of β_{μ} evaluations beginning with uniform coefficients.

FIG. 11: A method of selecting a molecular structure having a physical property of interest.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention can take the form of an entirely hardware embodiment, an entirely software (including firmware, resident software, micro-code, etc.) embodiment, or an embodiment containing both software and hardware aspects. Furthermore, the present invention can take the form of a computer program product on a computer-usable or computer-readable storage medium having computer-usable or computer-readable program code embodied in the medium for use by or in connection with an instruction execution system. In the context of this document, a computer-usable or computer-readable medium can be any structure that can contain, store, communicate, propagate, or transport the program for use by or in connection with the instruction execution system, apparatus, or device.

The computer-usable or computer-readable medium can be, for example, but is not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a removable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner if necessary, and then stored in a computer memory.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act as specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

These computations can be carried out on a range of computing devices, from single processor desktop computers to multi-processor supercomputers. The level of approximation, and hence the computing needs, is dictated by the property that is being optimized.

“Hamiltonian” as used herein has its conventional meaning in the art and refers to a mathematical construct that describes a compound or composition. Thus, the Hamiltonian refers to the sum of the kinetic and potential energy of the particles present in the molecule. In the case of quantum mechanics, the Hamiltonian includes a detailed description of both electrons and nuclei. In the case of classical mechanics, the Hamiltonian includes a description of atoms, rather then the constituent particles that make up the atoms. See, e.g., W. Kolos and L. Wolniewicz, Nonadiabatic Theory for Diatomic Molecules and Its Application to the Hydrogen Molecule, Rev. Mod. Phys. vol. 35, pp. 473-483 (1963); G. Woolley and B. T. Sutciffe, P.-O. Löwdin and the Quantum Mechanics of Molecules in Fundamental World of Quantum Chemistry, E. J. Brändas and E. S. Kryachko (Eds.), Vol. 1, 21-65, Kluwer Academic Publishers, 2003; C. Eckart, Some studies concerning rotating axes and polyatomic molecules, Physical Review, vol. 47, pp. 552-558 (1935); B. Podolsky, Quantium-mechanically correct form of Hamiltonian function for conservative system, Phys. Rev., vol. 32, p. 812 (1928); E. Bright Wilson, Jr. and J. B. Howard The Vibration-Rotation Energy Levels of Polyatomic Molecules I. Mathematical Theory of Semirigid Asymmetrical Top Molecules, J. Chem. Phys. vol. 4, pp. 260-268 (1936); B. T. Darling and D. M. Dennison, The water vapor molecule, Phys. Rev., vol. 57, pp. 128-139 (1940); J. K. G. Watson, Simplification of the molecular vibration-rotation Hamiltonian, Mol. Phys. vol. 15, 479-490 (1968); L. C. Biedenham and J. D. Louck, Angular Momentum in Quantum Physics, volume 8 of Encyclopedia of Mathematics, Addison-Wesley, Reading, 1981.

“Numerical Optimization” as used herein may be any suitable numerical optimization technique, including but not limited to combinatorial methods, derivative-free methods, first order methods, second order methods, etc. Particular methods of numerical optimization include, but are not limited to, gradient descent (also known as “steepest descent” or “steepest ascent”), Nelder-Mead methods (or “Amoeba methods”), subgradient methods, simplex methods, ellipsoid methods, bundle methods, Newton's method, Quasi-Newton methods, interior point methods, conjugate gradient methods, line searching, etc. See, e.g., R. Fletcher, “Practical methods of optimization,” John Wiley and Sons, New York, 1987; see also J. Nocedal and S. Wright, Numerical Optimization, Springer Verlag, 2d Ed. 2006.

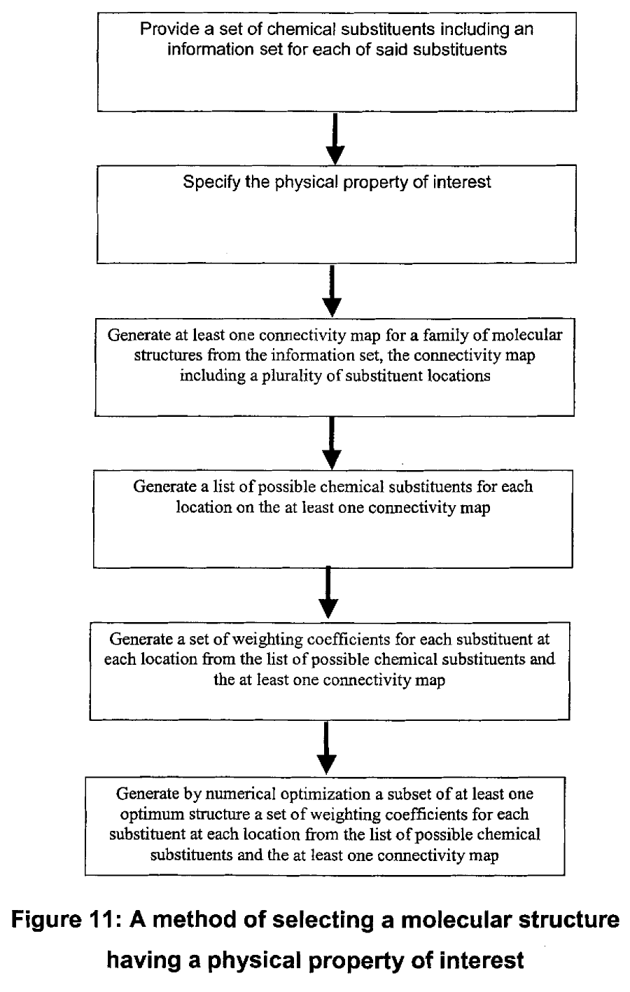

As schematically illustrated in FIG. 11, the present invention provides a method of selecting a molecular structure having a physical property of interest, comprising:

(a) providing a set of chemical substituents including an information set for each of said substituents (e.g., the information set comprising chemical valency, bond lengths and bond angles)

(b) specifying said physical property of interest;

(c) optionally, specifying at least one chemical constraint of said molecular structure;

(d) generating at least one connectivity map for a family of molecular structures from said information set, said connectivity map comprising a plurality of substituent locations;

(e) generating a list of possible chemical substituents for each location on said at least one connectivity map;

(f) generating a set of weighting coefficients for each substituent at each location from said list of possible chemical substituents and said at least one connectivity map;

(g) generating by numerical optimization a subset of at least one optimum structure from said physical property of interest, said list of possible chemical substituents at each site, and said set of weighting coefficients.

In some embodiments, the information set further comprising range of conformations (or “conforms”).

In some embodiments, the chemical constraint is maximum molecular weight, presence of double bonds, absence of double bonds, absence of halo groups, presence of halo groups, presence of at least one charged group; presence or absence of biocompatible groups; (e.g., for drug discovery applications), presence or absence of groups that alter solubility in a media of interest, presence or absence of metal species, and presence or absence of dipolar groups.

In some embodiments, the connectivity map comprises a linear map, a cyclic map, a branched map, or a combination thereof.

In some embodiments, the substituents comprise individual atoms or substituents of multiple chemically bonded atoms.

In some embodiments, the physical property is selected from the group consisting of: electronic hyperpolarizability, magnetic properties, conductivity, receptor binding, spectral absorption, spectral emission, intrinsic electronic, optical, or magnetic properties (e.g., conductivity, ferromagnetism, superconductivity, switchable properties (both linear and nonlinear), catalytic activity, a receptor-ligand binding characteristic, electrochemical reduction and oxidation properties, solar energy trapping and conversion properties, and spectral absorption or spectral emission properties.

In some embodiments, the molecular structure is an individual molecule or a crystal of molecules.

The method is useful in a variety of applications in organic chemistry, inorganic chemistry, and pharmaceutical sciences, including but not limited to the selection and design of catalysts, conductors, biologically active compounds, receptor binding compounds, light absorbing and/or emitting compounds for solar cell, diagnostic, and therapeutic applications, teaching related to all of the above, etc.

In general and in some embodiments, rather than considering an inaccessibly large library of possible structures, we cast the design of molecules as a problem requiring the search for the optimum nuclear-electron interaction potential function, v(r), that generates a molecular system with associated target properties. The atom types, and the nuclear positions determine v(r). As such, all molecular properties are determined by v(r) and the number of electrons N, because their knowledge allows, in principle, solution of the molecular Schrödinger equation. The potential function v(r) thus encodes all of the chemical information for a given N. The richness and complexity of molecular phenomena in chemistry, biology, and materials science arise—almost miraculously—from variations in v(r) and N. Analogous simplicity is seen in the density functional theory (DFT) of electronic structure in which molecular properties are functionals of the electron density, also a function of three spatial coordinates—just like v(r). Importantly, we construct a smooth surface that facilitates v(r) optimization and that enables linking optimum potentials to real molecules.

The potential function v(r) was treated as a variable in earlier studies of molecular optimization and molecular property computation. Molecular hyperpolarizabilities were shown to change smoothly as the molecular Hamiltonian was varied (Risser, S. M. et al., J. Am. Chem. Soc. 115, 7719-7728 (1993)). Recently, DFT was formulated in the space of potential functions—the potential functional approach for DFT (Yang, W. et al., Phys. Rev. Lett. 92, 146404 (2004))—which establishes the theoretical underpinnings for the optimized effective potential approach (Yang, W. & Wu, Q. Phys. Rev. Lett. 89, 143002 (2002)). Furthermore, optimization in the v(r) space has been formulated to produce a target electron density (rather than the more conventional opposite case) (Wu, Q. & Yang, W. J. Chem. Phys. 118, 2498- (2003)). These observations motivate us to pose the hypothesis that a systematic optimization approach might be developed to design potential functions that generate molecules with optimized properties.

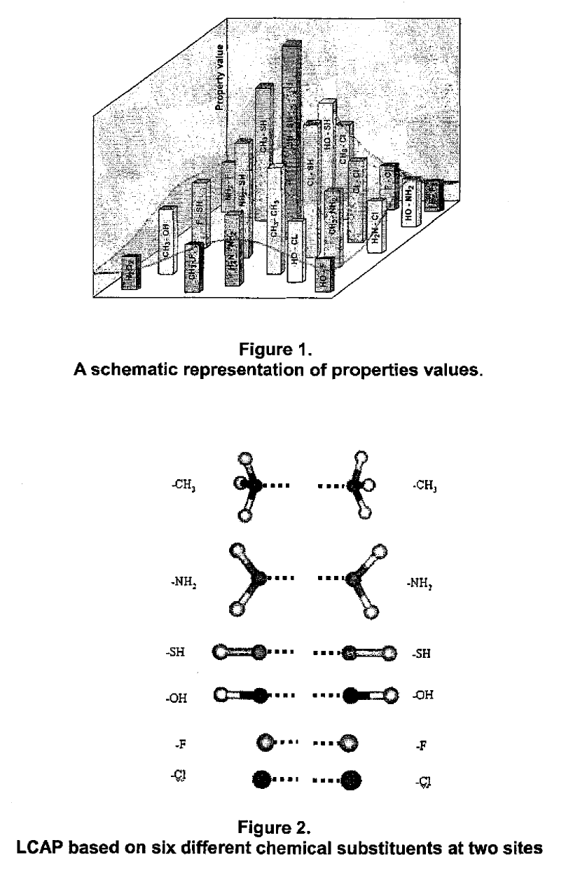

The advantages of optimization based on the potential arise from both the potential's “smoothness” and the favorable scaling of the computational cost with system size. The complexity of the potential function grows linearly with the molecular size. This is in stark contrast to the combinatorial explosion of possible molecular structures that would fill a growing molecular volume. The challenge at hand is how best to carry out the potential-function optimization; it is essential that the optimized potential has a linkage to real molecules. While all molecules lie within the space of all v(r)'s, not all potentials map back to chemical structures, or are C-representable (CR). A potential is CR (i.e., the potentials corresponding to the colored bars in FIG. 1) only if it arises from a set of Coulombic attractions between electrons and nuclei of integer charge, as in chemical species. Indeed, the optimal Hamiltonians determined in earlier studies were difficult to link directly to specific chemical structures. A full optimization in potential space most likely will lead to a potential that is not CR, since CR potentials are limited to a sum of Coulombic terms arising from integer nuclear charges.

To address the CR challenge, we develop here a construction for v(r) as a linear combination of atomic potentials (LCAP):

$$v ( r ) = {\sum }_{RA} {b}_{A}^{R} {v}_{A}^{R} ( r ) \qquad ( 1 )$$

where v_{A}^{R}(r) can be the potential of atom A at position R, or can arise from a collection of terms,

$${v}_{A}^{R} ( r ) = {\sum }_{B} {v}_{B} ( r ) ,$$

built from atoms {B} that form chemical building blocks. The parameter b_{A}^{R} defines the mixing strength of a part of the potential. The constraints on b_{A}^{R} are

$${\sum }_{B} {b}_{A}^{R} = 1$$

and 0≦b_{A}^{R}≦1. It is sometimes convenient to use pseudopotential methods to solve many-electron problems. In that case, the atomic potentials are usually non-local. Thus the LCAP function consists of parts centered at many possible sites (the sum over R) and each site accommodates a convex linear combination of possible v_{A}^{R}(r). A LCAP is CR if b_{A}^{R} values equal 0 or 1 for each R (species are either present or absent) and if no more than one b_{A}^{R} value is equal to one for each R (only pure species appear). Importantly, introducing the continuous values, b_{A}^{R}, in the LCAP formulates the optimization as occurring on a continuous hypersurface. Mapping onto a continuous surface avoids the need to enumerate the astronomical number of discrete chemical structures. Performing the optimization on this hypersurface may require, at the end of the analysis, rounding the optimal b_{A}^{R} values to the nearest integer to obtain one or more CR structures.

The variables in a LCAP computation are the set of sites R, the set of possible atoms or functional groups at each site as defined by the v_{A}^{R}(r), and the set of weighting coefficients b_{A}^{R}. The astronomical number of structures accessible for moderate-size organic molecules is based on counting the number of unique chemical substituents and considering linking together several of them using known covalent-bond chemistry. Employing a similar approach in the construction of the potentials, fragments library groups would determine available v_{A}^{R}(r) functions for each molecular site, and the fragments would be placed at positions (R) consistent with known rules of covalent bonding.

The LCAP thus continuously links all possible molecules, each site with a set of possible atoms or functional groups, through the variation in b_{A}^{R}. Note that the number of electrons present in the systems also changes continuously as the weighting coefficients vary.

Within the LCAP framework, the design of molecules with an optimized targeted property becomes the optimization of b_{A}^{R} values for given sets of R and v_{A}^{R}(r) (which themselves could be variables in the optimization). If the property surface is sufficiently smooth, the optimization should be efficient. If the optimal answer is close to a CR potential, then the design strategy is successful. We demonstrate that these two criteria are indeed met, and that the LCAP approach provides a promising strategy for molecular design.

An illustrative example is given for the optimization of electronic polarizability and hyperpolarizability with DFT calculations. The LCAP approach achieves this landscape smoothing by introducing the possibility of placing many nuclei, or groups of nuclei, simultaneously at a specific site and having many such designable sites. As such, the admixture of the potential terms is adjusted to optimize the target property. The values of the optimized coefficients define a real optimized structure, or a family of structures. The optimal structures that will be discovered are chosen to be built from a few well defined chemical species. FIG. 2 shows an example of a two site optimization with six possible chemical groups on each of the sites.

The polarizability a is calculated using the finite-field method (Chemla, D. S. & Zyss, J. Eds., Nonlinear optical properties of organic molecules and crystals (Academic Press, Orlando, 1987); Kurtz, H. A. & Dudis, D. S. Rev. Comp. Chem. 12, 241-279 (1998)):

$$α = {\sum }_{i}^{ } {α}_{ii} / 3 , {α}_{ii} = - [ E ( {F}_{i} ) + E ( - {F}_{i} ) - 2 E ( 0 ) ] / {F}^{2} ,$$

where i=x, y, or z. E(Fᵢ) is the DFT ground state electronic energy of the system in the presence of a field Fᵢ. The derivative of the polarizability with respect to the coefficients is calculated using ∂E(Fᵢ)/∂b_{A}^{R}, which is computed using the Hellman-Feynman theorem (see Supporting Material). We also change the LCAP coefficients to a new set of variables t_{A}^{R} where

$${b}_{A}^{R} = {( {t}_{A}^{R} )}^{2} / {\sum }_{R} {( {t}_{A}^{R} )}^{2} ;$$

the constraints on b_{A}^{R} can be satisfied without constraining t_{A}^{R}.

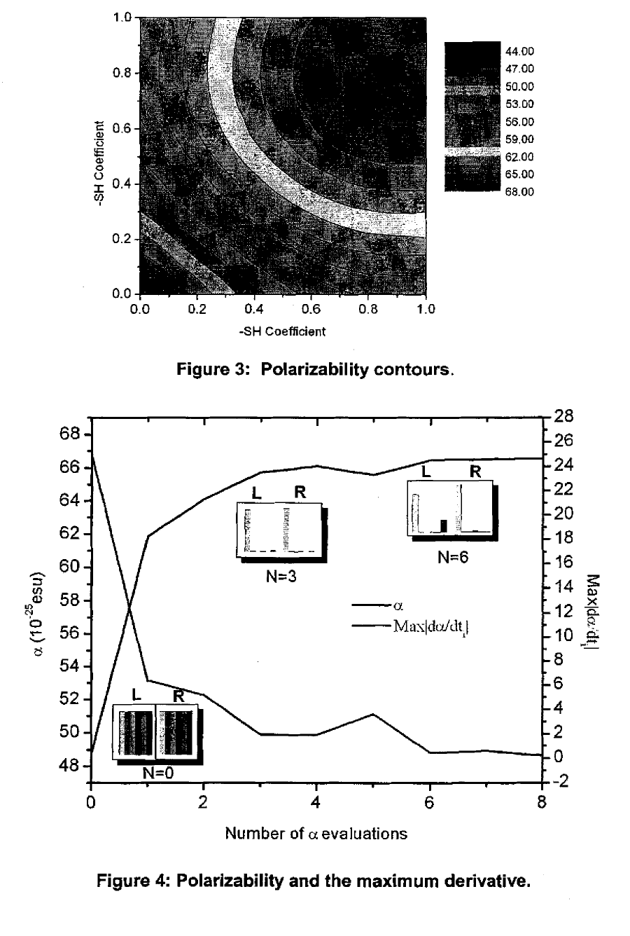

We used norm-conserving pseudopotentials produced with the FHI98PP program (Fuchs, M. & Scheffler, M. Comp. Phys. Comm. 119, 67-98 (1999)) in the local-density approximation. An energy cutoff of 100 Ry is used to determine the number of plane-wave basis functions. An external field of 0.02 au was applied to calculate the electronic polarizability. The molecule was placed in a cubic box with sides of length 8.5 Å. A quasi-Newton optimization algorithm was used to optimize the polarizability, and a system with two designable sites was studied. First, the two functional groups —CH₃ and —SH were placed at each of the two sites. The distance between the heavy atoms was fixed at 1.53 Å, a bond length typical of a single covalent bond. The bond and dihedral angles were chosen based on experimental geometries of the corresponding molecules. FIG. 3 is a contour map of polarizability as a function of the two weighting coefficients: one is associated with the presence of an —SH group on the left site and one is associated with the presence of an —SH group on the right site. The contour map shows that the polarizability changes very smoothly with variation of the two weighting coefficients. The maximum polarizability is found for b_{A}^{R} values of 0.87 and 0.74, when the system is composed of 87% —SH and 13% —CH₃ at one site, and 74% —SH and 26% —CH₃ at the other site. The asymmetry in these values arises from the slightly different torsional interactions for the —SH groups with their —CH₃ partners at the other site in the two structures. Beginning with uniform initial coefficients, the calculation converges to the correct maximum point with a few polarizability evaluations. Ten additional runs, beginning with random initial guesses, were performed and all converged to the same optimum point. The optimization indicates that the H₂S₂ molecule (fixed 90° torsion angle) is the structure with maximum polarizability among the four possible choices (representing three chemically distinct molecules).

FIG. 4 shows the progress of the optimization beginning with uniform initial coefficients for six functional groups (—CH₃, —OH, —NH₂, —F, —Cl, —SH) at each of two sites. The results converge within a few polarizability calculations to the maximum point of the property surface with 100% of —SH at one site and 76% —SH at the other site. Ten additional runs beginning with random initial guesses converge to the same maximum. No other local maxima were found. Therefore, the calculation uniquely identifies the optimum molecule for the given property. The calculation indicates that the H₂S₂ (fixed 90° torsion angle) molecule is the structure with maximum polarizability among all possible choices, in agreement with direct enumeration and evaluation. Even in this simple case, the LCAP optimization identifies the optimum molecule much more efficiently than the conventional approach of enumerating and evaluating candidate molecules one by one. The LCAP optimization is essentially completed after four function evaluations, optimizing ten degrees of freedom (five on each site) in these calculations. As such, optimization avoids enumerating structures and evaluating properties for all 21 possible molecular structures.

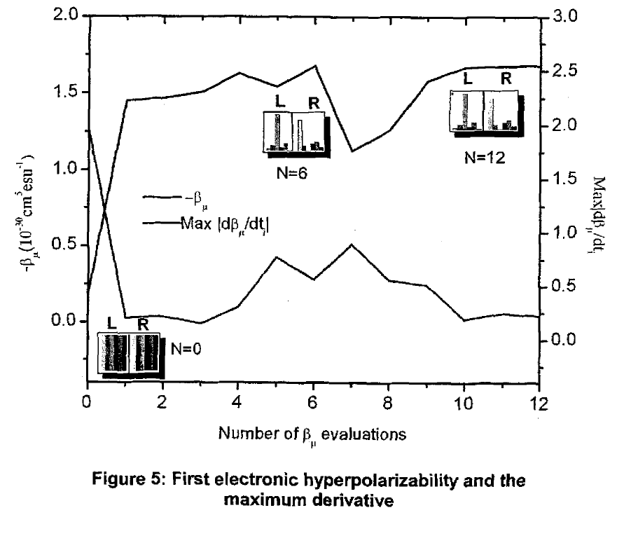

We have also applied the LCAP approach to optimize the first hyperpolarizability β_{μ} (see below). Since the hyperpolarizability is more expensive to compute than the polarizability ultra-soft pseudopotentials were used in the DFT analysis (Fuchs, M. & Scheffler, M. Comp. Phys. Comm. 119, 67-98 (1999)). The molecule was placed in a cubic box with sides of length 18 a₀. An energy cutoff of 476 eV was used to determine the size of the plane-wave basis set. An external field of 7.71×10⁻³ V/Å was applied to calculate the electronic first hyperpolarizability. FIG. 5 shows the progress of the optimization beginning with uniform initial weighting coefficients. The gradients decrease rapidly within a few steps, and |β_{μ}| reach a maximum. The optimized structure has 67% weighting of fluorine at one site and 57% weighting of —SH at the other (FIG. 5), indicating F—SH is the optimal molecule. This optimized chemical structure is in agreement with the results of direct enumeration and evaluation of all hyperpolarizabilities. Our focus above has been on the optimization scheme, and we have not yet discussed issues of molecular geometry as fragments are brought together. In formulating the optimization scheme, we assumed that changes in bond lengths and bond angles (including the bond linking the fragments), upon forming the composite molecule from a library of “standard” fragments, have a modest effect on the property values, especially on the relative values. This simplification is validated in the set of 21 structures of FIG. 2 and the four push-pull polyenes studied in the Supporting Material. We have also assumed that considering only a single “standard” fragment geometry is sufficient to carry out the optimization (validated by the two specific families of structures examined). Indeed, both of these simplifications can be relaxed, as described in the following two schemes.

The first scheme addresses the issue of geometry relaxation caused by electronic changes in the molecule upon bonding the standard fragments: the output chemical structure can be geometry optimized and used as the starting point for another LCAP optimization cycle. This procedure can be iterated until self-consistency is obtained. Importantly, our aim is not to find a global energy minimum or absolute maximum property for a prescribed chemical formula. Rather, we intend to determine the most favorable chemical structure within a restricted family of structures that could be assembled from the standard molecular fragment library. A second scheme, completely within the LCAP optimization framework, aims to explore further the conformational space for a given chemical structure. This scheme, combined with the first, addresses changes in non-covalent interactions upon assembling the molecule from its fragments. This scheme would input a family of thermally-accessible conformers for each standard fragment as independent variable units in the LCAP optimization. In this procedure, the optimization would identify not only the most favorable standard fragment, but also its most satisfactory conformation from the perspective of the property. Both of these schemes should be accessible computationally. This discussion has focused on local geometries and geometry changes upon assembling a molecule from structural fragments. Following the identification of promising lead structures, thermal-averaging could be pursued for the structures and the properties in the condensed-phase environment of interest.

The LCAP approach described here maps an intrinsically discrete molecular optimization problem onto a set of continuous variables, making efficient optimization possible. Framing our calculations in this way leads to optimized structures that can be realized chemically. In the examples examined here, optimal structures were identified much more rapidly than could be accomplished with exhaustive enumeration and evaluation of properties. Multiple property optima could result from this analysis: a) if multiple extrema were found in the property surfaces, or b) if optima were found with comparable weightings of multiple chemical groups at the same site. In either case, several structures would be suggested and more detailed analysis could be carried out on this refined list of potential targets.

The specific calculations implemented here show that molecular electronic polarizability and hyperpolarizability are indeed smooth functions of the LCAP coefficients and that the optimal molecule can be determined efficiently. Importantly, the LCAP approach maps the molecular search problem onto a smooth hypersurface, avoiding the need for direct enumeration and evaluation of all candidates structures. The cost of the LCAP optimization will grow linearly with molecular size (and is also proportional to the cost of calculating the property of interest). This is a particular benefit over the combinatorial growth in the number of molecular structures, and hence the computational cost, with molecular weight. In this regard, the LCAP approach has similarities to neural-network optimizations of challenging NP-complete problems (Hopfield, J. J. & Tank, D. W. Science, 233, 625-633 (1986)).

Since the LCAP approach can be implemented with classical or quantum Hamiltonians, many kinds of property optimization can be explored using this scheme. As such, the LCAP approach appears to provide a promising theoretical framework to address broader challenges in molecular design. Combining LCAP methods with conformational sampling may provide a systematic approach to address open challenges in the design of biological ligands with tailored binding characteristics or new materials with optimized properties. The challenge now is to expand the library of chemical building blocks so that a large and diverse universe of structures can be explored and optimized.

### EXAMPLES

### 1. Molecular Geometry in the LCAP Scheme

The molecular fragment approach of building molecules assumes that structure can be assembled approximately from a sum of “standard” parts, molecular fragments. When steric and electronic interactions among fragments have a substantial impact on the property of interest, the optimization scheme can be adjusted to account for these effects.

A. Geometry sensitivity of properties and molecular fragmentation. In optimizing the polarizabilities and hyperpolarizabilities of the 21 small molecules associated with FIG. 2 in the text, we assumed a fixed bond length (1.53 Å) for the bond between the two fragments. This assumption produced favorable property values compared with experiment, and the correct ordering of polarizabilities (Table 1). The viability of this fragment approach was subjected to a more challenging test on a family of push-pull polyenes, reasoning that delocalization and charge transfer mediated by a pi-electron bridge define a worst-case for the viability of the fragment approach.

TABLE 1
Polarizabilities (1 a.u. = 1.4819 × 10⁻²⁵ esu) and hyperpolarizabilities
(1 a.u. = 8.63922 × 10⁻³³ esu) of molecules based on combinations
of functional groups.

| | Calculated | Experimental | Calculated |
|---|---|---|---|
| Structure | α (10⁻²⁵ esu) | α (10⁻²⁵ esu) | β_{μ} (10⁻³³ esu) |
| CH₃—CH₃ | 45.46 | 44.80 (5) | 0.0 |
| CH₃—SH | 56.92 | — | 641.38 |
| ^{a}SH—SH | 65.41 | — | −628.59 |
| CH₃—OH | 35.27 | 33.19 (5) | −646.21 |
| CH₃—NH₂ | 42.62 | 40.13 (8) | −589.54 |
| CH₃—F | 28.51 | 26.10 (5) | −722.58^{a} |
| CH₃—Cl | 45.11 | 45.30 (5) | −149.63 |
| ^{a}H₂O₂ | 26.05 | 22.87 (6) | −423.67 |
| Cl—Cl | 45.02 | 44.98 (7) | 0.0 |
| NH₂—F | 32.57 | — | −835.93 |
| NH₂—SH | 52.37 | — | −177.62 |
| HO—NH₂ | 32.84 | — | −879.47 |
| HO—F | 19.98 | — | −349.02 |
| HO—Cl | 34.71 | — | 267.47 |
| HO—SH | 45.52 | — | 133.69 |
| F—F | 14.70 | 12.42 (7) | 0.0 |
| F—Cl | 28.48 | — | −1093.73 |
| F—SH | 38.90 | — | −1472.99 |
| Cl—SH | 56.52 | — | 405.01 |
| H₂N—NH₂ | 39.80 | 34.63 (8) | −17.62 |
| H₂N—Cl | 41.73 | — | −305.83 |

^{a}The H₂O₂ and H₂S₂ structures are assumed locked in non-centrosymmetric geometries with a torsion angles of 90°.
^{b}B3LYP/Aug-POL calculation: 728.55 × 10⁻³³ esu from (7)

We examined the first hyperpolarizabilities of the following structures:

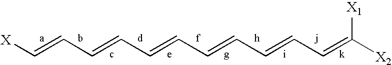

The library of donor/acceptor groups is indicated in the Table 2 below

TABLE 2
HF/STO-3G Optimized bond lengths (Å).

| | |
|---|---|
| 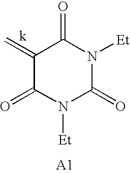 | 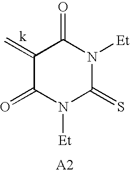 |

| | Donors | | M1 | M2 | M3 | M4 |
|---|---|---|---|---|---|---|
| | (X) −> | H | NH₂ | NBu₂ | NEt₂ | NEt₂ |
| Bond | a | 1.315 | 1.328 | 1.329 | 1.326 | 1.326 |
| Lengths | b | 1.484 | 1.474 | 1.477 | 1.475 | 1.475 |
| | c | 1.324 | 1.326 | 1.327 | 1.326 | 1.326 |
| | d | 1.479 | 1.476 | 1.476 | 1.476 | 1.476 |
| | e | 1.325 | 1.326 | 1.327 | 1.326 | 1.326 |
| | f | 1.478 | 1.477 | 1.476 | 1.476 | 1.476 |
| | g | 1.325 | 1.326 | 1.327 | 1.326 | 1.327 |
| | h | 1.479 | 1.477 | 1.474 | 1.476 | 1.476 |
| | i | 1.324 | 1.325 | 1.329 | 1.328 | 1.328 |
| | j | 1.484 | 1.479 | 1.470 | 1.473 | 1.473 |
| | k | 1.315 | 1.322 | 1.339 | 1.335 | 1.335 |
| | Acceptors | H, H | H, CHO | CN, CN | A1 (struct. | A2 (struct. |
| | (X1, X2) −> | | | | above) | above) |

TABLE 3
Properties (esu) calculated using HF/6-31+g optimized structures.

| | | | β(0) · μ | | β(0) · μ/ | | βₜₒₜ (0) | |
|---|---|---|---|---|---|---|---|---|
| | \|μ\|(×10⁻¹⁸) | | (×10⁻⁴⁸) | | \|μ\|(×10⁻³⁰) | | (×10⁻³⁰) | |
| Molecule | S1 | S2 | S1 | S2 | S1 | S2 | S1 | S2 |
| M1 | 8.482 | 8.408 | −508.9 | −457.4 | −60.0 | −54.4 | 63.5 | 62.2 |
| M2 | 11.832 | 11.573 | −1231.7 | −1219.8 | −104.1 | −105.4 | 118.1 | 111.2 |
| M3 | 8.106 | 7.872 | −1171.3 | −1101.3 | −144.5 | −139.9 | 147.3 | 142.7 |
| M4 | 8.815 | 8.533 | −1414.8 | −1307.3 | −160.5 | −153.2 | 163.8 | 156.6 |

For S1: the full structure is optimized at the HF/STO-3G level;
For S2: the structure is built from fragments based on the separte donor, acceptor and bridge units.

In the molecular constructions (note “S2” in Table 3), the double bond nearest the donor or acceptor unit is included in its fragment. That is, we take the geometry of the four double bonds in the molecule's center from a H(HC═CH)₆H calculation. Table 2 compares the geometries of the pure polyene and its substituted derivatives. The data indicate that the molecular geometry of the bridge changes little on donor/acceptor substitution. Table 3 similarly shows that hyperpolarizabilities change little when the structure of the full molecule is approximated by uniting the geometries of the fragment parts. The optimizations and comparisons are based on gas phase calculations; hyperpolarizabilities of strongly solvatochromic structures should be treated using a model that includes explicit solvation; the calculations described here apply best to low dielectric media. When such solvent effects are important, the self-consistent procedure below could be used to make corrections arising from more significant structural changes than observed in the two case studies described here.

B. Self-consistent geometry optimization in the LCAP framework. Interactions among fragments will perturb its structure through steric and electronic interactions. An approach to including the influence of electronic interactions (that caise changes in orbital hybridization and chemical bonding, for example) among molecular fragments is to optimize the geometry of the LCAP optimized structure. The geometry optimized structure could then be used to modify the geometry of the input fragments and the LCAP analysis would then be repeated. This procedure could be continued until self-consistency is reached.

C. Inclusion of multiple fragment conformers in the optimization. The self-consistent procedure described above would include electronic interactions among fragments but would not sample conformational space widely. If the molecular property has a strong conformational dependence, the LCAP sum in Eq. (1) of the text can include different conformations of the fragments. This procedure would be analogous to adopting a library of amino acid rotamers, as is often done when modeling protein structure.

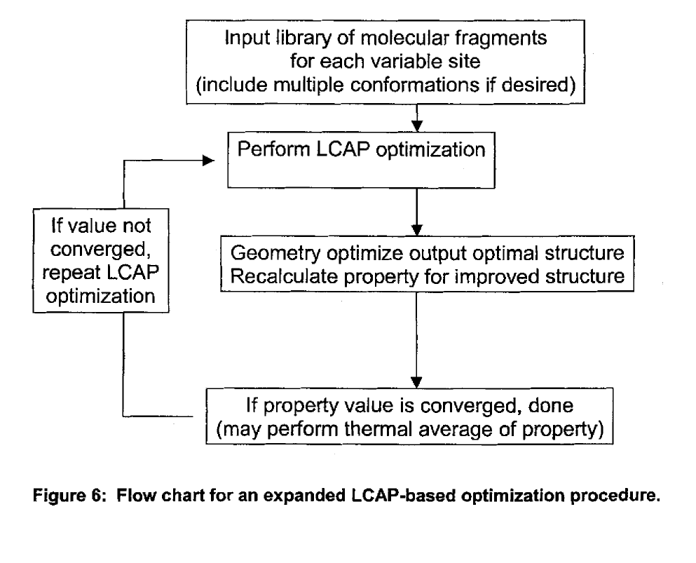

D. Summary of hybid geometry/LCAP optimization schemes. The approaches described above are illustrated in FIG. 6 and could be used to expand the scope of the LCAP optimizations described in the text.

### 2. Details of the LCAP Density Functional (DFT) Calculations

We implement the LCAP optimization in DFT calculations using the norm-conserving pseudo-potentials (NCPP) and ultra-soft pseudopotentials (USPP) based on a plane wave basis set (K. Lassonen et al., Phys. Rev. B, 1993, 47, 10142; L. Kleinman, D. M. Bylander, Phys. Rev. Lett., 1982, 48, 1425). The NCPP can be regarded as a special case of the USPP with the augmentation function Qₙₘ(r) equal to zero and one reference energy only being used. For clarity, only the USPP is discussed here. The USPP is [2]:

$$\begin{matrix}{v}_{A} ( r , {r}^{′} ) = {v}_{A}^{loc} ( r ) δ ( r - {r}^{′} ) + {v}_{A}^{nl} ( r , {r}^{′} ) \\ = {v}_{A}^{loc} ( r ) δ ( r - {r}^{′} ) + {\sum }_{nm} {D}_{nm}^{0} \vert {β}_{n}^{A} 〉 〈 {β}_{m}^{A} \vert ,\end{matrix} \qquad ( S .1 )$$

where the Dₙₘ⁰ and βₙ^{A} characterize the USPP for atom A.

The LCAP potential is expanded:

$$v ( r , {r}^{′} ) = {\sum }_{R , A} {b}_{A}^{R} {v}_{A}^{R} ( r , {r}^{′} ) , \qquad ( S .2 )$$

Thus,it can be written in USPP form as:

$$\begin{matrix}v ( r , {r}^{′} ) = {\sum }_{R , A} {b}_{A}^{R} {v}_{A}^{R , loc} ( r ) δ ( r - {r}^{′} ) + \\ {\sum }_{R , A} {b}_{A}^{R} {v}_{A}^{R , nl} ( r , {r}^{′ } ) \\ = {\sum }_{R , A} {b}_{A}^{R} {v}_{A}^{R , loc} ( r ) δ ( r - {r}^{′} ) + \\ {\sum }_{R , A} {b}_{A}^{R} {\sum }_{nm} {D}_{nm}^{0} \vert {β}_{n}^{A} 〉 〈 {β}_{m}^{A} \vert\end{matrix} \qquad ( S .3 )$$

The first term is the total local potential v^{loc}(r) and the second term is the total non-local potential v^{nl}(r,r′).

The total energy of the system in an external electric field is:

$$E ( {F}_{x} ) = {\sum }_{i} 〈 {φ}_{i} \vert - \frac{{ℏ}^{2}}{2 m} {∇}^{2} + {v}^{nl} ( r , {r}^{′} ) \vert {φ}_{i} 〉 + {E}_{H} [ n ( r ) ] + {E}_{xc} [ n ( r ) ] + {\int }_{ }^{ } d r ( {v}^{loc} ( r ) - xF ) n ( r ) \qquad ( S .4 )$$

The derivative of energy with respect to the b_{A}^{R} coefficients is computed with a fixed number of electrons N to be:

$$\begin{matrix}{\frac{\partial E ( {F}_{x} )}{\partial {b}_{A}^{R}} \vert}_{N} = \frac{\partial }{\partial {b}_{A}^{R}} \{ {\sum }_{i} 〈 {φ}_{i} \vert - \frac{{ℏ}^{2}}{2 m} {∇}^{2} + {v}^{nl} ( r , {r}^{′} ) \vert {φ}_{i} 〉 + \\ {E}_{H} [ n ( r ) ] + {E}_{xc} [ n ( r ) ] + \\ {\int }_{ }^{ } d r ( {v}^{loc} ( r ) - xF ) n ( r ) \} \\ = {\sum }_{i} [ 〈 \frac{\partial {φ}_{i}}{\partial {b}_{A}^{R}} \vert - \frac{{ℏ}^{2}}{2 m} {∇}^{2} + {v}^{nl} ( r , {r}^{′} ) \vert {φ}_{i} 〉 + c . c . ] + \\ {\int }_{ }^{ } {\underbrace{[ {V}_{H} ( r ) + {V}_{xc} ( r ) + {v}^{loc} ( r ) - xF ]}}_{{V}_{eff} ( r )} \frac{\partial n ( r )}{\partial {b}_{A}^{R}} d r + \\ {\sum }_{i} 〈 {φ}_{i} \vert {v}_{A}^{nl} ( r , {r}^{′} ) \vert {φ}_{i} 〉 + {\int }_{ }^{ } {v}_{A}^{R , loc} ( r ) n ( r ) d r .\end{matrix} \qquad ( S .5 )$$

The electron density n(r) is:

$$n ( r ) = {\sum }_{i} [ {\vert {φ}_{i} \vert}^{2} + {\sum }_{A , R} {b}_{A}^{R} {\sum }_{nm} {Q}_{nm}^{A} 〈 {φ}_{i} \vert {β}_{n}^{A} 〉 〈 {β}_{m}^{A} \vert {φ}_{i} 〉 ] . \qquad ( S .6 )$$

From the above equation

$$\frac{\partial n ( r )}{\partial {b}_{A}^{R}}$$

is obtained:

$$\frac{\partial n ( r )}{\partial {b}_{A}^{R}} {= \sum }_{i} {\sum }_{nm} {Q}_{nm}^{A} ( r ) 〈 {φ}_{i} \vert {β}_{n}^{A} 〉 〈 {β}_{m}^{A} \vert {φ}_{i} 〉 + {\sum }_{i} [ \frac{\partial {Q}_{i}^{*}}{\partial {b}_{A}^{R}} {φ}_{i} + c . c . ] + {\sum }_{i} {\sum }_{A , R} {b}_{A}^{R} {\sum }_{nm} {Q}_{nm}^{A} ( r ) [ 〈 \frac{\partial {φ}_{i}}{\partial {b}_{A}^{R}} \vert {β}_{n}^{A} 〉 + c . c . ] \qquad ( S .7 )$$

Based on Eq. S.7, Eq. S.5 can be written:

$$\begin{matrix}{\frac{\partial E ( {F}_{x} )}{\partial {b}_{A}^{R}} \vert}_{N} = {\sum }_{i} {\sum }_{nm} {\underbrace{( {D}_{nm}^{0} + \int {V}_{eff} ( r ) {Q}_{nm}^{A} ( r ) d r )}}_{{D}_{nm}^{I , A}} 〈 {φ}_{i} \vert {β}_{n}^{A} 〉 〈 {β}_{m}^{A} \vert {φ}_{i} 〉 + \\ {\int }_{ }^{ } {v}_{A}^{R , loc} ( r ) n ( r ) d r + \\ {\sum }_{i} ( 〈 \frac{\partial {φ}_{i}}{\partial {b}_{A}^{R}} \vert \underbrace{( \begin{matrix}- \frac{{ℏ}^{2}}{2 m} {∇}^{2} + {V}_{eff} ( r ) + \\ {\sum }_{R , A} {b}_{A}^{R} {\sum }_{nm} {D}_{nm}^{I , A} \vert {β}_{n}^{A} 〉 〈 {β}_{m}^{A} \vert\end{matrix} )}_{ \hat{H}} \vert {φ}_{i} 〉 + c . c . ) \\ = {\sum }_{i} {\sum }_{nm} {D}_{nm}^{I , A} 〈 {φ}_{i} \vert {β}_{n}^{A} 〉 〈 {β}_{m}^{A} \vert {φ}_{i} 〉 + \\ {\int }_{ }^{ } {v}_{A}^{R , loc} ( r ) n ( r ) d r + \\ {\sum }_{i} ( 〈 \frac{\partial {φ}_{i}}{\partial {b}_{A}^{R}} \vert \hat{H} \vert {φ}_{i} 〉 + c . c . )\end{matrix} \qquad ( S .8 )$$

Using Ĥ|φᵢ [symbol] =εᵢS|φᵢ [symbol] , we obtain

$$( 〈 \frac{\partial {φ}_{i}}{\partial {b}_{A}^{R}} \vert \hat{H} \vert {φ}_{i} 〉 + c . c . ) = {ɛ}_{i} ( 〈 \frac{\partial {φ}_{i}}{\partial {b}_{A}^{R}} \vert S \vert {φ}_{i} 〉 + c . c . ) \qquad ( S .9 )$$

where S is a Hermitian overlap operator:

$$S = 1 + {\sum }_{R , A} {\sum }_{nm} {b}_{A}^{R} {q}_{nm}^{A} \vert {β}_{n}^{A} 〉 〈 {β}_{m }^{A} \vert \qquad ( S .10 )$$

The generalized orthonormality condition [symbol] φᵢ|S|φᵢ [symbol] =δᵢⱼ gives

$$( 〈 \frac{\partial {φ}_{i}}{\partial {b}_{A}^{R}} \vert S \vert {φ}_{i} 〉 + c . c . ) + 〈 {φ}_{i} \vert \frac{\partial S}{\partial {b}_{A}^{R}} \vert {φ}_{i} 〉 = 0 \qquad ( S .11 )$$

and Eq. S.9 can be written:

$$\begin{matrix}( 〈 \frac{\partial {φ}_{i}}{\partial {b}_{A}^{R}} \vert \hat{H} \vert {φ}_{i} 〉 + c . c . ) = - {ɛ}_{i} 〈 {φ}_{i} \vert \frac{\partial S}{\partial {b}_{A}^{R}} \vert {φ}_{i} 〉 \\ = - {ɛ}_{i} {\sum }_{nm} {q}_{nm}^{A} 〈 {φ}_{i} \vert {β}_{n}^{A} 〉 〈 {β}_{m}^{A} \vert {φ}_{i} 〉\end{matrix} \qquad ( S .12 )$$

Substituting Eq. S.12 into Eq. S.8, the derivative of the total energy with respect to b_{A}^{R} is:

$$\frac{\partial E ( {F}_{x} )}{\partial {b}_{A}^{R}} {\vert}_{N} = {\sum }_{i} {\sum }_{nm}^{ } {D}_{nm}^{I , A} 〈 {φ}_{i} \vert {β}_{n}^{A} 〉 〈 {β}_{m}^{A} \vert {φ}_{i} 〉 + \int {v}_{A}^{R , loc} ( r ) n ( r ) d r - {\sum }_{i}^{ } {ɛ}_{i} {\sum }_{nm}^{ } {q}_{nm}^{A} 〈 {φ}_{i} \vert {β}_{n}^{A} 〉 〈 {β}_{m}^{A} \vert {φ}_{i} 〉 \qquad ( S 13 )$$

Similarly, the derivative of the energy with respect to b_{A}^{R} for a fixed potential v^{nl}(r,r′) is:

$$\frac{\partial E ( {F}_{x} )}{\partial {b}_{A}^{R}} {\vert}_{v ( r , {r}^{′} )} = \frac{\partial E ( {F}_{x} )}{\partial N} \frac{\partial N}{\partial {b}_{A}^{R}} = {μ}_{chem} {Z}_{A}^{R} \qquad ( S .14 )$$

Here, the constraint

$$N = {\sum }_{A , R}^{ } {Z}_{A}^{R}$$

is applied to insure a neutral molecule. μ_{chem} is the chemical potential of the system, and Z_{A}^{R} is the atomic number of atom A at site R.

Finally, the derivative of the energy with respect to the coefficients b_{A}^{R} is:

$$\frac{\partial E ( {F}_{x} )}{\partial {b}_{A}^{R}} = {\sum }_{i} {\sum }_{nm}^{ } {D}_{nm}^{I , A} 〈 {φ}_{i} \vert {β}_{n}^{A} 〉 〈 {β}_{m}^{A} \vert {φ}_{i} 〉 + \int {v}_{A}^{R , loc} ( r ) n ( r ) d r - {\sum }_{i}^{ } {ɛ}_{i} {\sum }_{nm}^{ } {q}_{nm}^{A} 〈 {φ}_{i} \vert {β}_{n}^{A} 〉 〈 {β}_{m}^{A} \vert {φ}_{i} 〉 + {μ}_{chem} {Z}_{A}^{R} \qquad ( S .15 )$$

Note that the above equations also apply to the norm-conserving pseudopotentials, as special cases, when we set Qₙₘ^{A} and qₙₘ ^{A} to zero,

The polarizability α can be calculated using finite-field methods ((H. A. Kurtz et al., J. Comp. Chem., 1990, 11, 82; H. A. K. B. Kurtz, S. D. Douglas, Rev. Comp. Chem. 12, 241 (1998)):

$${α}_{ii} = - \frac{1}{{F}^{2}} [ {E}_{tot} ( + {F}_{i} ) + {E}_{tot} ( - {F}_{i} ) - 2 E ( 0 ) ] \qquad ( S .16 )$$

where i is the index x, y, z. Based on Eq. S.15, the derivative of the polarizability with respect to the b_{A}^{R} coefficient is:

$$\frac{\partial {α}_{ii}}{\partial {b}_{A}^{R}} = - \frac{1}{{F}^{2}} [ \frac{\partial E ( + {F}_{i} )}{\partial {b}_{A}^{R}} + \frac{\partial E ( - {F}_{i} )}{\partial {b}_{A}^{R}} - 2 \frac{\partial E ( 0 )}{\partial {b}_{A}^{R}} ] \qquad ( S .17 )$$

The hyperpolarizability β_{μ} is defined by

$${β}_{μ} = \frac{{\sum }_{i}^{ } {β}_{i} {μ}_{i}}{\vert μ \vert} ( i = x , y , z ) .$$

The electric dipole moment μᵢ^{e} is calculated with the finite-field method as:

$${μ}_{i}^{e} = [ - \frac{2}{3} \{ E ( {F}_{i} ) - E ( - {F}_{i} ) \} + \frac{1}{12} \{ E ( 2 {F}_{i} ) - E ( - 2 {F}_{i} ) \} ] / {F}_{i} \qquad ( S .18 )$$

The molecular dipole is:

$${μ}_{i} = {μ}_{i}^{e} + {\sum }_{R , A}^{ } {b}_{A}^{R} {Z}_{A}^{R} {R}_{i}^{A} \qquad ( S .19 )$$

The derivative of the molecular dipole with respect to b_{A}^{R} is

$$\frac{\partial {μ}_{i}}{\partial {b}_{A}^{R}} = \frac{\partial {μ}_{i}^{e}}{\partial {b}_{A}^{R}} + {Z}_{A}^{R} {R}_{i}^{A} \qquad ( S .20 )$$

The βᵢ components are

$${β}_{i} = {\sum }_{j}^{ } {β}_{ijj} ( j = x , y , z ) .$$

Each βᵢⱼⱼ component is calculated using the finite-field method:

$$\begin{matrix}{β}_{iii} = [ - \frac{1}{2} \{ E ( 2 {F}_{i} ) - E ( - 2 {F}_{i} ) \} + \{ E ( {F}_{i} ) - E ( - {F}_{i} ) \} ] / {F}_{i}^{3} in case of j = i , & ( S .21 ) \\ {β}_{ijj} = [ \frac{1}{2} \{ E ( - {F}_{i} , - {F}_{j} ) - E ( {F}_{i} , {F}_{j} ) + E ( - {F}_{i} , {F}_{j} ) - E ( {F}_{i} , - {F}_{j} ) \} + \{ E ( {F}_{i} ) - E ( - {F}_{i} ) \} ] / {F}_{i} {F}_{j}^{2} for j \neq i . & ( S .22 )\end{matrix}$$

Like the calculation of

$$\frac{\partial {α}_{ii}}{\partial {b}_{A}^{R}} , \frac{\partial {μ}_{i}^{e}}{\partial {b}_{A}^{R}} and \frac{\partial {β}_{i}}{\partial {b}_{A}^{R}}$$

are computed based on Eq. S.15.

### Finally,

$$\frac{\partial {β}_{μ}}{\partial {b}_{A}^{R}}$$

is given by:

$$\frac{\partial {β}_{μ}}{\partial {b}_{A}^{R}} = \frac{1}{\vert μ \vert} {\sum }_{i = 1}^{3} ( {β}_{i} \frac{\partial {μ}_{i}}{\partial {b}_{A}^{R}} + {μ}_{i} \frac{\partial {β}_{i}}{\partial {b}_{A}^{R}} ) - \frac{1}{{\vert μ \vert}^{3}} ( {\sum }_{i = 1}^{3} {β}_{i} {μ}_{i} ) {\sum }_{i = 1}^{3} {μ}_{i} \frac{\partial {μ}_{i}}{\partial {b}_{A}^{R}} \qquad ( S .23 )$$

3. Results for a System with Two Designable Sites

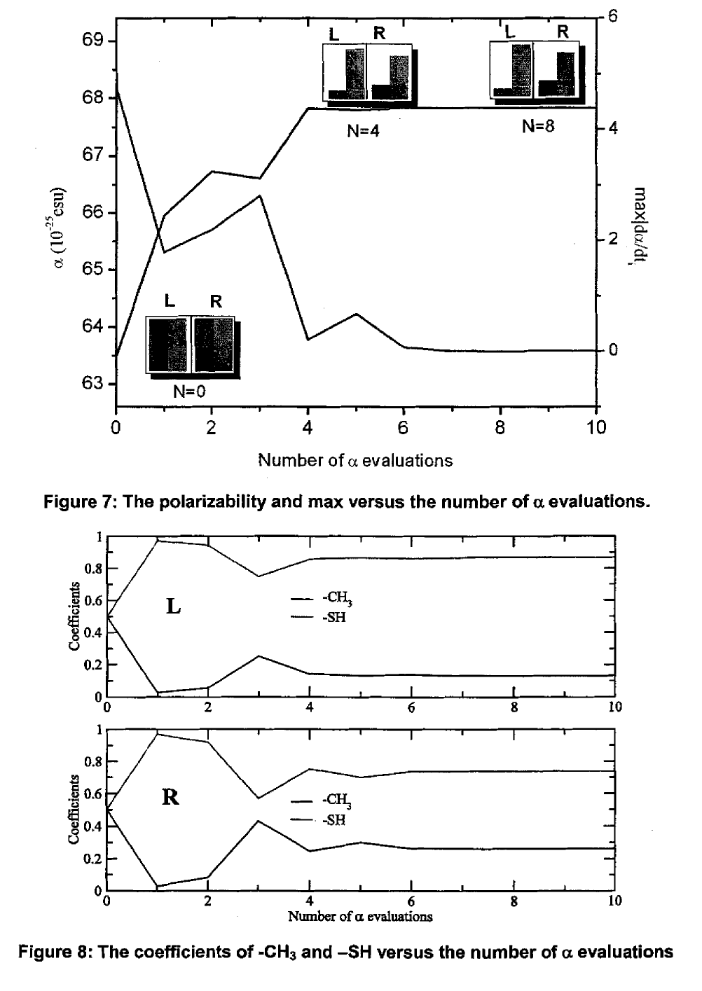

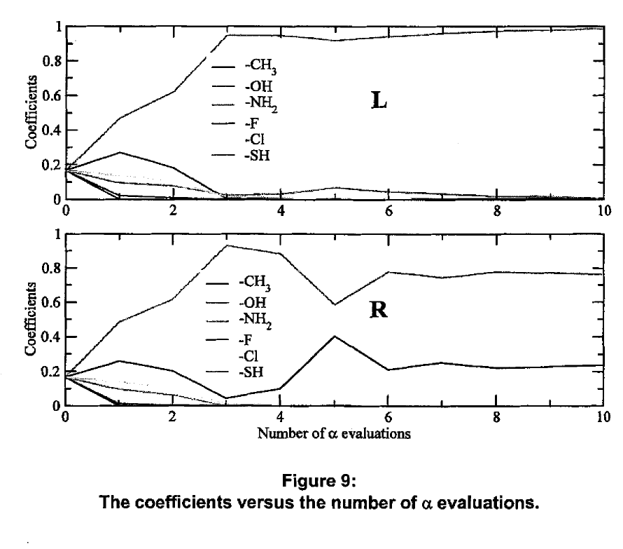

FIGS. 7 and 8 show the optimization results beginning with uniform initial coefficients in the case of two functional groups (—CH₃ and —SH). The results converge at the maximum with 87% —SH at one site and 74% —SH at the other site within a few α calculations, and the gradients decrease to zero. The optimized results indicate that the —SH group dominants both designable sites. This means the linear polarizability optimized molecule is H₂S₂. FIG. 9 shows results in the case of six functional groups (—CH₃, —OH, —NH₂, —F, —Cl, and —SH), at each of two sites, beginning with uniform initial coefficients. H₂S₂ is the molecule with the maximum electronic polarizability. Table 1 gives the polarizabilities of all possible structures.

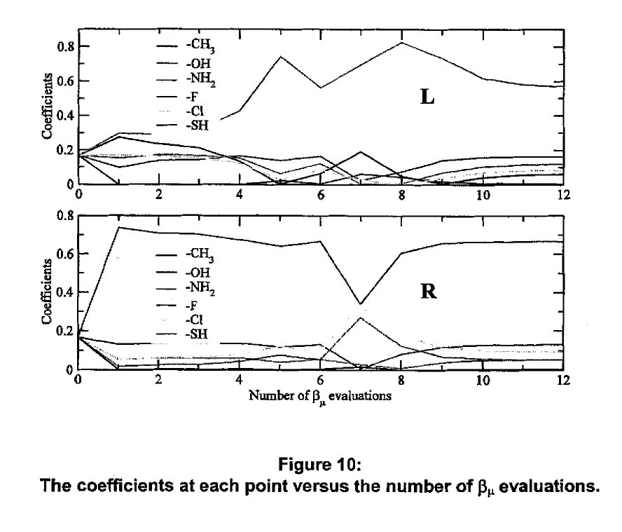

FIG. 10 shows optimized coefficients for hyperpolarizability, beginning with uniform initial coefficients in the case of six functional groups (—CH₃, —OH, —NH₂, —F, —Cl and —SH). It shows that the system has maximum hyperpolarizability with 57% —SH at one site and 67% fluorine at the other site, i.e., SH—F. This result is in agreement with the direct enumeration and evaluation (Table 1). The calculated hyperpolarizability based on finite-field analysis with plane wave basis sets is in accordance with PW91PW91/aug-cc-pvtz Gaussian03 results (Gaussian 03, Revision C.02, M. J. Frisch et al., Gaussian, Inc., Wallingford, Conn., 2004).

### 4. Polarizabilities and Hyperpolarizabilities of all Possible Molecules

Table 1 lists the computed electronic polarizabilities and hyperpolarizabilities of all possible structures obtained by enumerating the structures and computing the values one by one.

### Additional References.

The following additional references and resources may also be referred to or utilized in carrying out the present invention:

S. Baroni et al., A. Dal Corso, S. de Gironcoli, P. Giannozzi, C. Cavazzoni, G. Ballabio, S. Scandolo, G. Chiarotti, P. Focher, A. Pasquarello, K. Laasonen, A. Trave, R. Car, N. Marzari, A. Kokalj, Plane-Wave Self-Consistent Field, INFM crs DEMOCRITOS, SISSA, via Beirut 2-4, 34014 Grignano, Trieste, Italy (tel: +39-0403787443; fax: +390403787528).

P. T. Duijnen, M. Swart, J. Phys. Chem. A. 1998, 102, 2399.

E. Barbagli, M. Maestro, Chem. Phys. Lett. 1974, 24, 567.

W. Koch, M. C. Holthausen, A Chemist's Guide to Density Functional Theory, 2^{nd} Ed. (Wiley-VCH, New York, 2001).

G. Schürer, P. Gedeck, M. Gottschalk, T. Clark, Int. J. Quan. Chem. 1999, 75, 17.

The foregoing is illustrative of the present invention, and is not to be construed as limiting thereof. The invention is defined by the following claims, with equivalents of the claims to be included therein.

That which is claimed is:

1. A method of selecting a molecular structure having a physical property of interest, comprising:
(a) providing a set of chemical substituents including an information set for each of said substituents, said information set comprising chemical valency, bond lengths and bond angles
(b) specifying said physical property of interest;
(c) optionally, specifying at least one chemical constraint of said molecular structure;
(d) generating at least one connectivity map for a family of molecular structures from said information set, said connectivity map comprising a plurality of substituent locations;
(e) generating a list of possible chemical substituents for each location on said at least one connectivity map;
(f) generating a set of weighting coefficients for each substituent at each location from said list of possible chemical substituents and said at least one connectivity map;
(g) generating by numerical optimization a subset of at least one optimum structure from said physical property of interest, said list of possible chemical substituents at each site, and said set of weighting coefficients.

2. The method of claim 1, further comprising said step (c) of specifying at least one chemical constraint of said molecular structure;

3. The method of claim 1, wherein said information set further comprising range of conformations (or “conforms”).

4. The method of claim 1, wherein said numerical optimization is carried out a combinatorial method, a derivative-free method, a first order method, or a second-order method.

5. The method of claim 1, wherein said chemical constraint is maximum molecular weight, presence of double bonds, absence of double bonds, absence of halo groups, presence of halo groups, presence of at least one charged group; presence or absence of biocompatible groups; (for potential drug discovery applications), presence or absence of groups that alter solubility in a media of interest, presence or absence of metal species, and presence or absence of dipolar groups.

6. The method of claim 1, wherein said connectivity map comprises a linear map, a cyclic map, a branched map, or a combination thereof.

7. The method of claim 1, wherein said substituents comprise individual atoms or substituents of multiple chemically bonded atoms.

8. The method of claim 1, wherein said physical property is selected from the group consisting of: electronic hyperpolarizability, magnetic properties, conductivity, receptor binding, spectral absorption, spectral emission, intrinsic electronic, optical, or magnetic properties (e.g., conductivity, ferromagnetism, superconductivity, switchable properties (both linear and nonlinear), catalytic activity, a receptor-ligand binding characteristic, electrochemical reduction and oxidation properties, solar energy trapping and conversion properties, and spectral absorption or spectral emission properties.

9. The method of claim 1, wherein said molecular structure is an individual molecule or a crystal of molecules.

10. A computer program product comprising a computer usable storage medium having computer-readable program code stored in the media, the computer readable program code configured to perform the method of claim 1.

11. A computer system configured to perform the method of claim 1.
